(19) United States
(12) Patent Application Publication
(10) Pub. No.: US 2023/0150078 A1
(43) Pub. Date: May 18, 2023

(54) PROCESSING APPARATUS FOR OPTICAL WORKPIECES AS WELL AS USE OF A DOUBLE GRIPPER

(71) Applicant: Schneider GmbH & Co. KG, Fronhausen (DE)

(72) Inventors: Helwig BUCHENAUER, Dautphetal (DE); Klaus HOFMANN, Wehrheim (DE); Marcel MAHNER, Fronhausen (DE)

(21) Appl. No.: 17/985,292

(22) Filed: Nov. 11, 2022

(30) Foreign Application Priority Data
Nov. 12, 2021 (DE) 10 2021 005 630.2
Feb. 11, 2022 (DE) 10 2022 000 537.9

(51) Int. Cl. B23Q 5/22

(52) U.S. Cl. CPC B23Q 5/22

(57) ABSTRACT

A processing apparatus for optical workpieces and the use of a double gripper are proposed, wherein a swivelable changing device with a double gripper is arranged between a milling station and a turning station. Thus, parallel processing can be performed in the milling station and the turning station and the workpiece changing time can be minimized.

### BACKGROUND

The present disclosure relates to a processing apparatus for processing, in particular shape cutting or machining, optical workpieces, in particular lenses or eyeglass lenses, as well as to a use of or method of using a double gripper for changing optical workpieces for processing in a processing apparatus.

Optical workpieces, in particular lenses or eyeglass lenses, are processed, preferably machined, in particular by milling and/or (lathe) turning, on the flat side for shaping.

German Patent Appliction DE 10 2015 102 900 A1 and corresponding U.S. Pat. Application US 2016/250690 A1 disclose a manufacturing device for eyeglass lenses with a milling device and a turning device as well as a changing device. The turning device has two turning stations, which each comprise a workpiece spindle and an associated fast tool drive with a turning tool. The workpiece spindles are movable transversely to the turning tools and in the direction of the turning tools by means of a cross slide. The milling device also has a workpiece spindle on a cross slide and two associated milling drives. The workpiece spindles are parallel to each other and aligned in the same direction. By means of the changing device, a lens blank can be removed from the milling device after milling and transferred to the turning device. The changing device comprises two gripping devices, each of which has two suckers pointing away from each other by 90°, the gripping members being jointly linearly movable and jointly pivotable about an axis of rotation. To change the lens blanks, the workpiece spindles must each be moved into a loading position between the milling device and the turning device, and the changing device must also be moved linearly between the two devices over a relatively long distance transverse to the spindle axes from the milling device to the turning device and vice versa.

German Patent Application DE 10 2006 050 425 A1 discloses an apparatus for milling and turning lenses with a milling station and a turning station as well as a changing device. The milling station has a workpiece spindle arranged on a cross slide and an associated milling drive with a milling tool. The turning station has a workpiece spindle arranged on a cross slide and an associated fast tool drive with a turning tool. The two workpiece spindles are aligned parallel to each other and in the same direction, and are movable selectively to a loading position between the two stations. The changing device is used for loading and unloading with the lenses in the loading position. To change the lenses, the workpiece spindles must be moved alternately into the loading position. The changing device has a swivel arm with a gripping member arranged at its free end, which member has two suckers pointing away from each other and can be swiveled about a further swivel axis running obliquely to the spindle axis and perpendicular to the swivel axis of the swivel arm. For changing the respective lens on a workpiece spindle, the swivel arm is movable linearly and the gripping member is swivelable.

German Patent Application DE 43 10 038 A1 discloses a lathe with two opposing workpiece spindles, each of which can be moved in the direction of the spindle axis and transversely thereto. A workpiece is transferred from one workpiece spindle to the other without the aid of a changing device simply by the infeed motion of the spindles. After a first workpiece side has been machined by the first workpiece spindle, a second workpiece side is machined in this way by the second workpiece spindle. Sequential processing of the same workpiece surface by the two workpiece spindles is not possible.

German Patent Application DE 10 2007 045 591 A1 discloses a processing machine for processing workpieces, in particular for milling and/or turning bar-shaped workpieces, with two workpiece spindles that are movable in two spatial directions. For double-sided machining, a direct transfer can take place between the two workpiece spindles. Sequential processing of the same workpiece surface by the two workpiece spindles is not possible.

### SUMMARY

It is an object of the present disclosure to provide a processing apparatus and a use of a double gripper, which enable processing, in particular machining, of optical workpieces, in particular lenses or eyeglass lenses, with high throughput, high precision and/or short changeover times and/or which enable a simple and/or compact design/structure.

The above object is solved by a processing apparatus or by a use of or method of using a double gripper as disclosed herein.

Preferably, the processing apparatus has a milling station with a first workpiece spindle and/or a turning station with a second workpiece spindle and preferably a changing device for changing the workpieces or lenses to be processed.

According to a first aspect of the present disclosure, the workpiece spindles or their chucks preferably face each other and/or the changing device is arranged therebetween. This enables an optimized arrangement of the changing device, in particular so that a particularly fast change of the workpieces or lenses between the milling station and turning station is made possible by swiveling the changing device.

Preferably, the changing device is constructed and/or arranged in such a way that the workpiece is or can be transferred to the respective workpiece spindles with the same, in particular a blocked, side, and/or that processing of the same side and/or the same surface can be carried out by means of the milling station and the turning station.

According to a second aspect of the present disclosure, which can also be implemented independently, the turning station and the milling station preferably each have only a maximum of two stacked axes of motion. This is conducive to a simple structure and/or high precision during processing.

“Stacked axes of motion” or “stacked movement axes” are preferably axes which are stacked on top of each other and/or coupled with each other and/or axes of a single moving part of the station or device, in particular the axes of motion of the workpiece spindle and/or the tool. Preferably, two axes of motion are “stacked” and/or “coupled” when one of the axes of motion is displaced when moving along the other axis of motion.

In other words, preferably, the workpiece spindle of a station can only move in a maximum of two directions and/or along a maximum of two axes, and the tool can likewise only move in a maximum of two directions and/or along a maximum of two axes.

In total, the respective station may have more than two axes of motion, for example four axes of motion, in which case preferably the workpiece spindle has two stacked axes of motion and the tool also has two stacked axes of motion, so that the station then has a maximum of only two stacked axes of motion in total. In other words, the station does not have three or more stacked axes anywhere.

It is also possible for the station or individual parts thereof to have no stacked axes. For example, the tool spindle and/or tool could be movable in only one direction or have only one axis of motion.

Preferably, only axes for linear movements/motion are to be understood by the term “stacked axes of motion”. Thus, one or more rotary axes may be present in addition to the only maximal two stacked (linear) motion axes.

According to a third aspect of the present disclosure, which can also be implemented independently, the changing device preferably has a double gripper, which is rotatable about an in particular central turn axis and is movable linearly along this axis and/or –in particular by means of a cam mechanism – is designed for superimposed rotary and linear movement. This in turn is conducive to a simple design and/or a short changeover time and thus a high throughput.

Particularly preferably, the double gripper has two gripping members, in particular suckers, which point parallel to each other in the same direction.

Preferably, the milling station has a first carriage with a workpiece spindle and a second carriage with a milling drive, as well as a machine bed, wherein the machine bed supports/bears/mounts the first carriage on a first bearing surface and the second carriage on a second bearing surface.

According to a fourth aspect of the present disclosure, which can also be implemented independently, the two bearing surfaces of the (same) machine bed are inclined to each other by more than 45°, in particular by about 70° to 85°. Alternatively or additionally, the second bearing surface preferably extends parallel to the rotation axis of the milling drive. In particular, the carriage guide of the second carriage is fastened directly without intermediate elements to the second, preferably almost vertical, bearing surface of the machine bed. This enables a particularly stable and low-vibration structure with, in particular, a minimum number of stacked movement axes. This is conducive to a simple structure and/or high precision during processing.

Preferably, the turning station has a workpiece spindle and a first fast tool drive and is designed in particular for face turning.

According to a fifth aspect of the present disclosure, which can also be implemented independently, the turning station preferably has a second or additional fast tool drive which is structured differently from the first fast tool drive and/or which is provided for alternative and/or sequential processing of the same workpiece, in particular for processing the same side and/or same surface of the workpiece. This enables in particular two-stage turning processing (e.g. first coarser/faster, then finer/slower) of the same workpiece. This is conducive to high throughput and/or high precision during processing.

According to a sixth aspect of the present disclosure, which can also be implemented independently, the turning station preferably has a wedge adjustment for the fast tool drive or drives, in particular wherein the slope and/or steepest inclination of the wedge adjustment is transverse to the fast tool movement axis and/or spindle axis of the workpiece spindle. This is conducive to a simple and/or compact design and/or minimization of stacked movement axes.

According to a seventh aspect of the present disclosure, which can also be implemented independently, the fast tool drive preferably has two tools and/or tool holders for alternative and/or sequential processing of a workpiece, in particular for processing the same side and/or same surface of the workpiece, and/or preferably has a tool cooling system. This is again conducive to high throughput and/or high precision during processing.

A proposed use of a double gripper is that the double gripper is rotatable about a turn axis and linearly movable along this axis and is designed, in particular by means of a cam mechanism, for superimposed rotary and linear movement in order to change the workpieces for processing in a processing apparatus or processing station and/or between different processing stations of the processing apparatus, in particular for processing the same side and/or same surface of the workpiece. Alternatively or additionally, the double gripper preferably simultaneously transfers a workpiece still to be processed and a workpiece already processed to different devices, in particular by means of a linear movement. This enables in particular very short changeover times and/or fast movements, thus a high throughput, as well as a simple design.

Individual ones of the foregoing and subsequent aspects and features of the present disclosure may be combined with each other in any desired manner, but may also be implemented independently of each other.

Further aspects, features, advantages and characteristics of the present disclosure will be apparent from the claims and the following description of a preferred embodiment with reference to the drawing.

### BRIEF DESCRIPTION OF THE DRAWINGS

FIG. 1 is a schematic top view of a proposed processing apparatus with a milling station, a turning station and a changing device;

FIG. 2 is a schematic side view of the processing apparatus;

FIG. 3 is a perspective view of the changing device with a double gripper;

FIG. 4 is a schematic side view of the turning station,

FIG. 5 is a front view of a fast tool drive of the turning station; and

FIG. 6 is a perspective rear view of a proposed milling tool of the milling station.

### DETAILED DESCRIPTION

In the figures, the same reference signs are used for the same components and parts, resulting in corresponding properties and advantages, even if a repeated description is omitted.

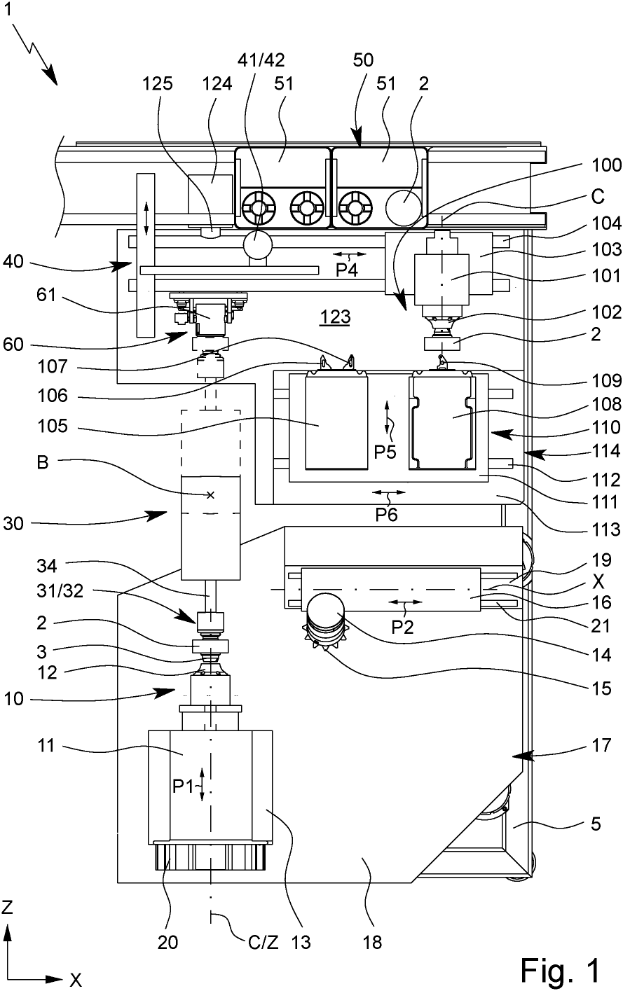

FIG. 1 shows a schematic top view of a processing apparatus 1 according to the proposal for processing, in particular for chipping/machining, optical workpieces, in particular lenses 2.

Particularly preferably, the workpiece or lens 2 is a so-called spectacle lens, i.e. a lens 2 for spectacles. In the following, instead of the optical workpiece, sometimes only the lens 2 is referred to, even if it can optionally also be another optical workpiece, such as a mirror or the like.

The workpiece or lens 2 preferably consists of plastic, but may also consist of glass or the like.

The workpiece or lens 2 preferably has a diameter of several centimeters, in particular more than three centimeters.

During processing, shaping and/or machining is preferably performed – in particular exclusively – on an optical surface and/or flat side of the lens 2, in particular for producing a so-called free-form surface, for example for a so-called prescription lens, thus for a spectacle lens individually adapted to a wearer. In particular, no edge processing takes place in the processing apparatus 1, although this is also optionally possible.

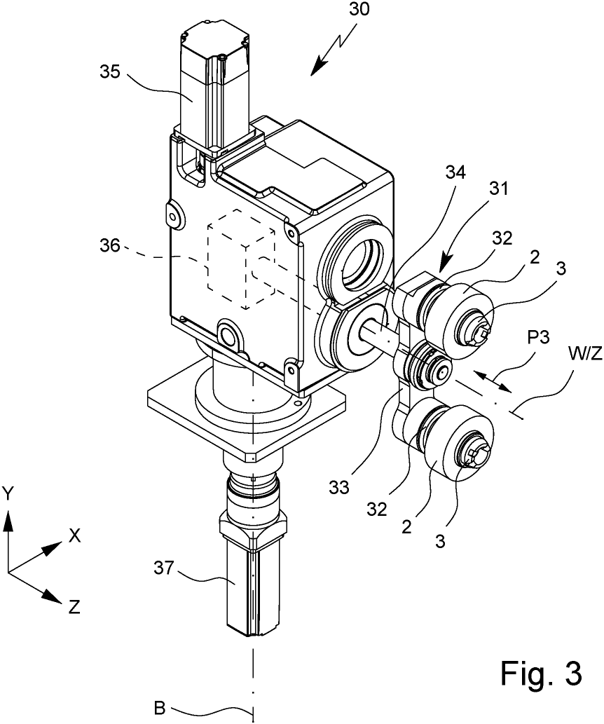

Preferably, the lens 2 is processed in the blocked state. The lens 2 is thus preferably provided with a temporary holder, a so-called block piece 3, as indicated in particular in FIG. 3, in order to be able to hold the lens 2 in particular in a defined and/or very simple manner during processing.

However, blockless processing or other holding during processing in the processing apparatus 1 is also possible in principle.

Preferably, the lens 2 is processed in the processing device 1 exclusively on one or the same (flat) side and/or (optical) surface, in particular the side/surface free of the block piece 3.

The processing apparatus 1 preferably has a milling station 10, a lathe / turning station 100, a changing device 30, a loading device 40, a conveying device 50 and/or a transfer device 60, as shown in FIG. 1.

The milling station 10 preferably has a workpiece spindle 11, in particular with a (clamping) chuck 12, for receiving the lens 2, in particular for holding the lens 2 on its block piece side, and is used in particular for milling processing (milling) the lens 2, i.e. processing/machining with a defined cutting edge, the cutting edge(s) of a milling tool 15 moving substantially faster than the lens 2.

The turning station 100 preferably has a workpiece spindle 101, in particular with a (clamping) chuck 102, for receiving the lens 2, in particular for holding the lens 2 on its block piece side, and is used in particular for turning processing (turning on a lathe) of the lens 2, particularly preferably by face turning. Here, the cutting speed of the machining processing is determined in particular by the rotational speed of the lens 2.

Preferably, the milling and turning operations are performed on the same (flat) side and/or (optical) surface of the lens 2.

The changing device 30 preferably serves to change and/or transfer the lens 2 from the milling station 10 to the turning station 100, in particular for (sequential) processing of the same side/surface of the lens 2 by means of the milling station 10 and the turning station 100, to load the milling station 10 and/or turning station 100 with a lens 2 to be processed and/or to remove a processed lens 2 from the milling station 10 and/or turning station 100 and/or to hand over the lens to the optional loading device 40 and/or or to take over the lens 2 from the optional loading device 40 and/or to otherwise feed or discharge lenses 2.

The processing apparatus 1 preferably has the conveying device 50 for feeding lenses 2 to be processed and/or conveying away processed lenses 2. The conveying device 50 can optionally also only be assigned to the processing apparatus 1, i.e. optionally not form part of the processing apparatus 1.

The conveying device 50 is particularly preferably designed as a conveyor band or belt conveyor.

The lenses 2 to be processed are preferably fed or supplied on or in transport carriers 51. Particularly preferably, the transport carriers 51 are designed as transport boxes and/or each serve to hold two lenses 2.

Preferably, the transport carriers 51 are also used for conveying away processed lenses 2.

The conveying device 50 is preferably arranged on one side, in particular a shorter side, of the processing apparatus 1.

The conveying direction and/or main extension direction of the conveying device 50 preferably runs parallel to one side of the processing apparatus 1 and/or in an X-direction and/or horizontally.

The lenses 2 to be processed are preferably picked up individually by means of the loading device 40 from the conveying device 50 and/or a transport carrier 51 and transferred / handed over to the changing device 30, particularly preferably with the optional transfer device 60 interposed. Alternatively, a transfer can also take place directly to a processing station, such as the milling station 10 or turning station 100.

The loading device 40 can also be formed by the changing device 30 or vice versa or form part of the changing device 30. Preferably, however, the loading device 40 is designed as a separate device from the changing device 30.

The processing apparatus 1 and/or loading device 40 preferably has the transfer device 60, which serves to hand over / transfer a lens 2 to the changing device 30 and/or to receive a lens 2 from the changing device 30.

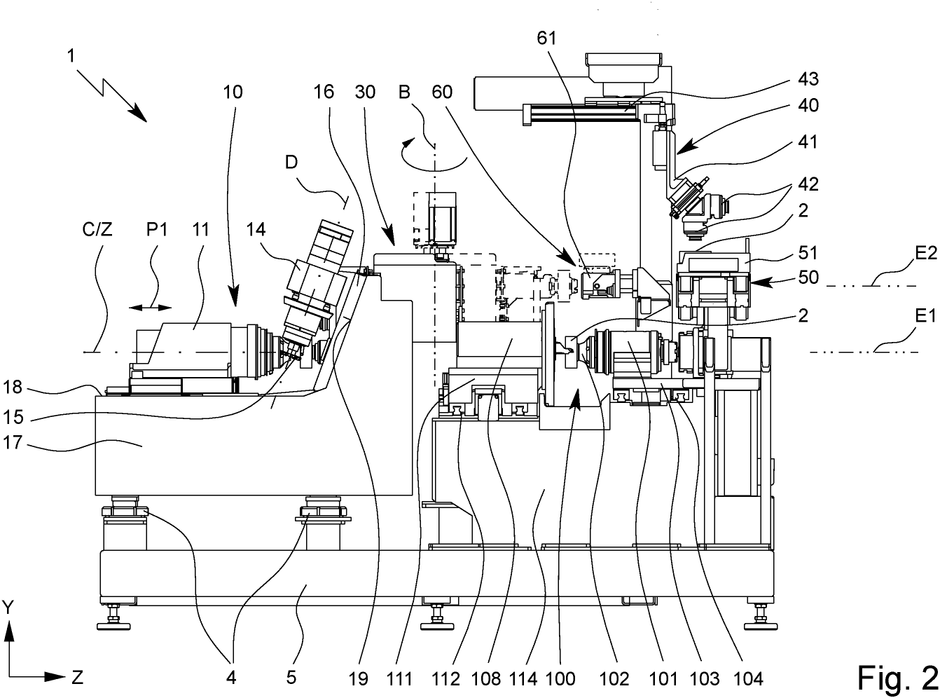

The transfer device 60 holds the lens 2 preferably on the block piece side and for this purpose has in particular a receiving chuck / pickup chuck 61, as indicated in the schematic side view according to FIG. 2.

Alternatively or additionally, the transfer device 60 preferably serves for changing the grip, so that the lens 2 can be gripped or held from the non-blocked or free flat side during further handling.

In the illustrative example, the loading device 40 preferably has a manipulator 41 with at least one gripping member or sucker 42, particularly preferably two gripping members or suckers 42, as indicated in particular in the schematic side view according to FIG. 2.

Particularly preferably, the two gripping members or suckers 42 are held on the manipulator 41 at an angle to one another and/or pointing away from one another and are rotatable and/or tiltable in such a way that selectively one gripping member or sucker 42 points in the direction for picking up or handing over a lens 2 – here downwards and/or for picking up from or handing over to the conveying device 50 or transfer device 60.

The loading device 40 and/or the manipulator 41 is preferably movable vertically in the direction of a Y-axis and horizontally in the direction of a Z-axis (transverse or perpendicular to the X-axis) and optionally also horizontally in the direction of the X-axis, which here runs perpendicular to the drawing plane of FIG. 2, in particular by means of corresponding slide guides / carriage guides 43, telescopic cylinders or the like.

The loading device 40 and/or the manipulator 41 can hold the lens 2 from above and/or on the unblocked side with the gripping member / sucker 42 and transfer the lens 2 –preferably without changing its orientation – to the transfer device 60, as indicated by dashed lines in FIG. 2.

If the transfer device 60 already holds a processed lens 2, the transfer device 60 and/or the manipulator 41 can first pick up this processed lens 2 from the transfer device 60 with the unoccupied gripping member or sucker 42 and then transfer the still unprocessed lens 2 previously removed from the conveying device 50 or from a transport carrier 51 to the transfer device 60 by means of the other gripping member or sucker 42.

For the transfer of the still unprocessed lens 2 to the changing device 30, the transfer device 60 or its chuck 61 is preferably moved and/or tilted in such a way that the lens 2 is moved and/or tilted from the orientation with its flat side facing upwards and/or from its horizontal orientiation into a vertical orientation in which the central lens axis runs horizontally and/or, in particular, in the Z direction and/or in which the unblocked flat side preferably points to the left in the illustration according to FIG. 2 and/or to the milling station 10 or the workpiece spindle 11 thereof.

The changing device 30 then takes over the lens 2 to be processed from the loading device 40 or transfer device 60. For this purpose, the changing device 30 grasps the lens 2 in particular on its unblocked flat side and/or the side to be processed or, as the case may be, also on the circumferential side. The dashed line in FIG. 1 shows how the changing device 30 takes the still unprocessed lens 2 from the transfer device 60.

The changing device 30 then transfers the unprocessed lens 2 preferably first to the milling station 10 or its workpiece spindle 11, as schematically indicated in FIG. 1.

Later, after milling, it is preferably provided that the changing device 30 transfers the milled lens 2 to the turning station 100.

Furthermore, it is preferably provided that the changing device 30, after turning, transfers the finished processed lens 2 from the turning station 100 again to the loading device 40 and/or transfer device 60.

In the following, a particularly preferred structure of the proposed changing device 30 is first explained in more detail.

FIG. 3 shows a schematic perspective view of a particularly preferred embodiment of the proposed changing device 30.

The changing device 30 preferably has a double gripper 31 with two gripping members or suckers 32, which preferably point in the same direction and/or are held by a common carrier 33.

FIG. 3 shows the changing device 30 and/or the double gripper 31 with two picked-up lenses 2. The suckers 32 hold the lenses 2 each on the unblocked flat side.

Instead of the suckers 32, however, grippers can also be used as gripping members, for example for gripping the lenses 2 on the circumferential side.

The lenses 2 are preferably held so that in each case the blocked flat side faces away from the changing device 30.

The changing device 30 preferably has an arm 34 which carries/supports the double gripper 31 and/or carrier 33 and/or the suckers 32, in particular at its free end, and is particularly preferably designed as a round rod or bar. In the example shown, the arm 34 holds the carrier 33 in the middle or centrally. However, other constructive solutions for holding and/or manipulating the double gripper 31 and/or the gripping members / suckers 32 are also possible.

The changing device 30 and/or the arm 34 and/or the double gripper 31 is preferably swivelable around a swivel axis B, in particular around a swivel angle of 180°. The swivel axis B preferably runs vertically and/or parallel to a Y-direction. Particularly preferably, the changing device 30 is swivelable as a whole about this swivel axis B. For this purpose, the changing device 30 preferably has a swivel drive 37.

In particular, at least one sucker 32 and/or the double gripper 31 is movable preferably axially with respect to the swivel axis B and/or linearly back and forth, in particular in the horizontal direction or Z-direction. This allows in particular a handover and/or take-over of a lens 2.

The changing device 30 is preferably designed to pick up the lens 2, in particular from the transfer device 60, in particular by means of a linear movement, here in the Z direction, as indicated by arrow P3, and to transfer it to the milling station 10 by swiveling about the swivel axis B, wherein a linear movement, in particular in the Z direction, is preferably again performed during the handover/transfer.

Preferably, the arm 34 and/or double gripper 31 is movable linearly (back and forth). The linear movement preferably runs along the direction of the longitudinal extension of the arm 34, transversely or perpendicularly to the swivel axis B, horizontally and/or parallel and/or coaxially to a feed direction Z and/or rotation axis C of the workpiece spindle 11 and/or 101. For this purpose, the changing device 30 preferably has a drive 35.

Particularly preferably, the arm 34 and/or double gripper 31 is rotatable about a turn axis W in order to be able to selectively use one of the two gripping members or suckers 32 for taking over or handing over a lens 2. The turn axis W preferably corresponds to the longitudinal axis of the arm 34 and/or corresponds to the linear axis of movement of the arm 34 and/or double gripper 31 and/or runs in the Z-direction, horizontally and/or radially with respect to the swivel axis B.

Particularly preferably, the changing device 30 has a cam gear or cam mechanism 36, shown schematically in FIG. 3, in order to achieve the desired rotation about the turn axis W and optionally to superimpose it on the linear movement - at least in sections and/or selectively.

Particularly preferably, the desired rotary movement is superimposed on the linear movement of the arm 34 and/or double gripper 31 by means of the cam mechanism 36. Tests have shown that particularly short changeover times can be achieved in this way.

The desired rotary movement is thus preferably realized by rotating the arm 34 about the turn axis W. In particular, the arm 34 is thus both axially movable and rotatable.

In the example shown, it is necessary to rotate the double gripper 31 by 180° about the turn axis W in order to use – instead of one gripping member or sucker 32 – the other gripping member or sucker as an alternative. In the example shown, this is due to the fact that the carrier 33 extends from the turn axis W and/or the arm 34 radially away in opposite directions towards the two gripping members or suckers 32. However, other constructive solutions are also possible, so that a rotation by 90°, for example, can be sufficient for changing between the two gripping members or suckers 32.

The total angle of rotation for changing from one gripping member or sucker 32 to the other gripping member or sucker 32 – i.e. for a turnover - is therefore preferably 180° in the example shown.

For a turnover, during retracting the double gripper 31 and/or during the linear movement towards the swivel axis B, the double gripper 31 is preferably already rotated by half the angle of rotation – thus by 90° in the example shown. However, other rotational angle divisions, for example ⅖ and ⅗, are also possible to achieve the total angle of rotation.

This rotary movement is preferably generated by means of the cam mechanism 36 and/or superimposed on the linear movement, so that the two movements can be executed very quickly overall. However, it is also possible in principle to execute the rotary movement after the linear movement when retracting.

A preferred process/sequence for lens changing is explained in the following.

After the unprocessed lens 2 has been picked up (in the example shown, preferably by the upper gripping member or sucker 32, in particular on the side to be processed) from the transfer device 60, the double gripper 31 and/or arm 34 is retracted axially and/or moved linearly in the direction of the swivel axis B and thus released from the transfer device 60 or its receiving chuck 61.

Subsequently, the changing device 30 and/or the double gripper 31 and/or the arm 34 and thus the picked-up lens 2 is swiveled around the B axis to the milling station 10 -by 180° in the example shown.

First, by moving the double gripper 31 linearly along the linear axis Z, a lens 2 that has already been completely processed by the milling station 10 is then gripped or sucked on with the free gripping member or gripper 32 (in the example shown, the lower gripping member or gripper 32), in particular on the side which has been processed by the milling station 10. Subsequently, the double gripper 31 is retracted again linearly and/or moved back in the direction of the swivel axis B in order to release/detach the gripped lens 2 from the milling station 10 (more precisely from the workpiece spindle 11 or its chuck 12 of the milling station 10).

This linear return movement is preferably superimposed by a (first) rotary movement, in particular over a first partial angle or half the angle of rotation, in order to execute the rotary movement as quickly as possible. During the subsequent axial advance towards the milling station 10 and/or workpiece spindle 11, a further (second) rotation takes place in the same direction of rotation, preferably again by half the angle of rotation or by a second partial angle (residual angle) to achieve the total angle of rotation, so that the unprocessed lens 2 is moved or rotated in front of the workpiece spindle 11 and is finally coupled to the chuck 12 and/or handed over to the milling station 10 and/or workpiece spindle 11 by the final linear movement.

To release/detach the lens 2 from the chuck 12, the rotary movement during retraction preferably starts only after a certain distance of purely linear movement and, when the arm 34 or double gripper 31 is extended, the rotary movement is already terminated before the end of the linear movement to enable a preferably linear coupling of the lens 2 with the chuck 12.

Preferably, the linear movement is adjustable to compensate for different thicknesses and/or geometries of the lenses 2 and/or the changing device 30 is equipped with a (spring) suspension (for example of the arm 34 or the gripping members or suckers 32) acting in the axial direction and/or direction of the turn axis W.

The optionally provided (spring) suspension in the axial direction and/or direction of the handover or pickup of a lens 2 and/or of the arm 34 or of the respective gripping member or sucker 32 or 42 or receiving chuck 61 can also be implemented independently and represents a particularly preferred aspect. In this way, particularly preferably, lenses 2 with different lens thicknesses and/or lens geometries can be handed over or picked up safely without having to vary the infeed accordingly.

After the lens 2 to be processed has been transferred / handed over to the milling station 10, the arm 34 is retracted again linearly, preferably with rotation of the double gripper 31. Then the changing device 30 is swiveled back to the transfer device 60 and/or to the turning station 100 about the swivel axis B.

With regard to a fast lens change and motion sequence, the transfer device 60 and the change position of the turning station 100 and/or workpiece spindle 101 are preferably in the same swivel position with respect to the swivel axis B, particularly preferably axially offset in the direction of the swivel axis B and/or in the vertical direction Y one above the other. For reasons of simplification, the workpiece spindle 101 in FIG. 1 is shown in a working position in front of a fast tool drive and not in its change position -here below the transfer device 60.

After swiveling to the turning station 100 / transfer device 60, the arm 34 and/or double gripper 31 is again extended linearly and preferably rotated further in order to then preferably first pick up a fully processed lens 2 from the turning station 100 or its workpiece spindle 101 with the free gripping member or sucker 32 – which is now lying in the lower position in the example shown – in particular on the side which has been processed by the turning station 100. In this case, the receiving chuck 61 of the transfer device 60 is preferably swiveled away, since the only milled lens 2 at the other (upper) sucker 32 is not delivered / handed over to the transfer device 60, but later in the next step to the turning station 100.

Next, the double gripper 31 is retracted again linearly and, after the initial purely linear movement, the rotary movement is again preferably superimposed on the return movement in order to rotate the double gripper 31, in particular by half the angle of rotation or 90°, about the turn axis W when retracting. Subsequently, the arm 34 with the double gripper 31 is again extended linearly and rotated further by half the angle of rotation, so that finally the milled lens 2 previously taken over from the milling station 10 lies in particular at the lower position and is handed over to the turning station 100 or its workpiece spindle 101 or its chuck 102, in particular wherein the milled side is facing away from the workpiece spindle 101 or its chuck 102.

In this way, a particularly fast lens change can be achieved at the turning station 100 or its workpiece spindle 101. This is conducive to a high throughput, since machining / shape cutting in the turning station 100 usually takes the longest time during processing, thus takes longer than milling in the milling station 10.

Particularly preferably, at the same time as the milled lens 2 is handed over to the turning station 100 or the workpiece spindle 101, the fully processed lens 2 is also handed over, particularly preferably to the transfer device 60. This is made easier or possible in particular by the use of the double gripper 31 and/or by gripping members / suckers 32 aligned in the same direction. In this way, a time-optimized sequence / process can also be achieved.

However, it is also possible in principle for the fully processed lens 2 to be delivered or handed over by the changing device 30 or its double gripper 31 in a separate step only after the milled lens 2 has been handed over to the turning station 100.

In the example shown, the lens 2 is preferably finished / fully processed when its flat side to be processed has been (lathe) turned and/or a desired surface shape (prescription surface) has been produced on the flat side to be processed by shape cutting / machining. This applies accordingly, of course, if both flat sides of a lens 2 are processed.

After delivery of the fully processed lens 2– in the example shown, to the transfer device 60 – the double gripper 31 and/or arm 34 is preferably retracted again linearly, wherein rotation or turn-over of the arm 34 and/or double gripper 31 is not necessary, especially since the double gripper 31 in this case is preferably not occupied with any lens 2.

Subsequently, the receiving chuck 61 and/or the lens 2 can be pivoted or tilted by the transfer device 60 - upwards in the example shown.

The loading device 40 then takes over the fully processed lens 2 from the transfer device 60 and hands it back to the conveying device 50 or places it back into a transport carrier 51, in particular into the same transport carrier 51 from which it was originally taken.

Finally, a new lens 2 to be processed is transferred / handed over to the transfer device 60 by means of the loading device 40, and the cycle or sequence can be continued or restarted accordingly by the changing device 30 and/or the double gripper 31 taking over the lens 2 to be processed from the transfer device 60 and then swiveling to the milling station 10.

A preferred design/structure of the milling station 10 is explained in more detail in the following.

The workpiece spindle 11 preferably has only one (linear) axis of movement, here in the feed direction or the feed axis Z, and/or is preferably arranged on a (first) carriage/slide 13 and in particular movable linearly back and forth in only one direction, here horizontally and/or in the Z direction and/or along the rotation axis C of the workpiece spindle 11, as indicated by arrow P1.

The milling station 10 preferably has a milling drive 14 with a milling tool 15, indicated schematically in FIG. 1, for machining or milling the lens 2.

The milling drive 14 preferably has only one linear axis of movement X and/or is preferably arranged on a (second) carriage/slide 16 and is preferably movable back and forth only transversely or perpendicularly to the workpiece spindle 11 and/or its axis of movement Z and/or rotation axis C, here in the X direction, as indicated by arrow P2, in particular so that the milling drive 14 with its milling tool 15 is movable in front of the workpiece spindle 11 or its chuck 12 for processing the lens 2.

Preferably, thus, the milling station 10 has only two individual and/or independent (linear) movement axes, wherein in particular one movement axis Z is assigned to the workpiece spindle 11 and the other movement axis X is assigned to the milling drive 14 and/or milling tool 15. Particularly preferably, the milling station 10 has no stacked (linear) movement axes.

If the rotary axes C and D of the workpiece spindle 11 and the milling drive 14 are also taken into account, the workpiece spindle 11 and/or the milling drive 14 each preferably have exactly two axes, namely one linear movement axis and one rotary axis.

Optionally, the milling drive 14 can also have an additional axis of movement, for example along the rotation axis D and/or a tilting axis. In the case of an additional linear movement axis, the two linear movement axes of the milling drive 14 are preferably stacked. Three stacked linear movement axes are preferably not provided.

The milling station 10 preferably has its own machine bed 17 with a first, in particular horizontal bearing surface / support surface 18 and a second, in particular inclined bearing surface / support surface 19, as indicated in particular in FIG. 2.

The workpiece spindle 11 is preferably arranged and/or mounted with its carriage 13 and/or the corresponding slide guide / carriage guide 20 directly on the first bearing surface 18 of the machine bed 17.

The milling drive 14 is preferably arranged and/or mounted with its carriage 16 and/or the corresponding slide guide / carriage guide 21 directly on the second bearing surface 19 of the machine bed 17.

The workpiece spindle 11 and/or the milling drive 14 thus preferably each have only a single axis of movement. Accordingly, a very simple and connection-stiff design/structure is possible.

The milling drive 14 and/or its rotation axis D, about which the milling tool 15 rotates, is preferably inclined by more than 45°, in particular more than 70°, for example about 85°, to the rotation axis C of the workpiece spindle 11 and/or horizontal plane X-Z.

Preferably, the second bearing surface 19 for the milling drive 14 is inclined by at least 45°, in particular more than 70°, for example about 85°, to the horizontal and/or to the rotation axis C of the workpiece spindle 11 and/or the rotation axis D of the milling drive 14 runs parallel to the second bearing surface 19. This in turn is conducive to a very simple and/or connection-stiff design/structure.

The milling drive 14 is preferably only movable in front of the workpiece spindle 11 by means of the carriage 16 to process the lens 2, and can be moved back to the starting position shown in FIG. 1 to allow the lens change by means of the changing device 30.

The movement axis Z of the workpiece spindle 11, the rotary axis or rotation axis C of the workpiece spindle 11 and the movement axis X of the milling drive 14 are in particular (position-)controlled axes and/or CNC axes.

The rotation axis D of the milling drive 14, on the other hand, does not have to be a (position-controlled) axis or CNC axis, even if the (rotational) speed is preferably controlled or feedback-controlled and/or adjustable or variable.

The milling station 10 and/or its machine bed 17 is preferably mounted/supported via damping elements 4 at or on a base frame 5 of the processing apparatus 1, as indicated in FIG. 2. However, other constructive solutions are also possible.

A particularly preferred design/structure of the proposed turning station 100 is explained in more detail in the following.

The workpiece spindle 101 of the turning station 100 preferably has only a single axis of movement, in particular transverse or perpendicular to its rotation axis C and/or in the horizontal direction, in particular in the X direction, as indicated by arrow P4 in FIG. 1.

In particular, the workpiece spindle 101 is arranged on a carriage/slide 103, which is movable or displaceable by means of its slide guide / carriage guide 104 correspondingly in the desired transverse direction and/or X-direction, in particular as indicated by arrow P4.

Preferably, the workpiece spindle 101 is movable in particular by means of the carriage 103 – here in the transverse direction X or X-direction – from the change position for lens change to the processing position in front of a fast tool drive 105, 108 and vice versa, as indicated by arrow P4.

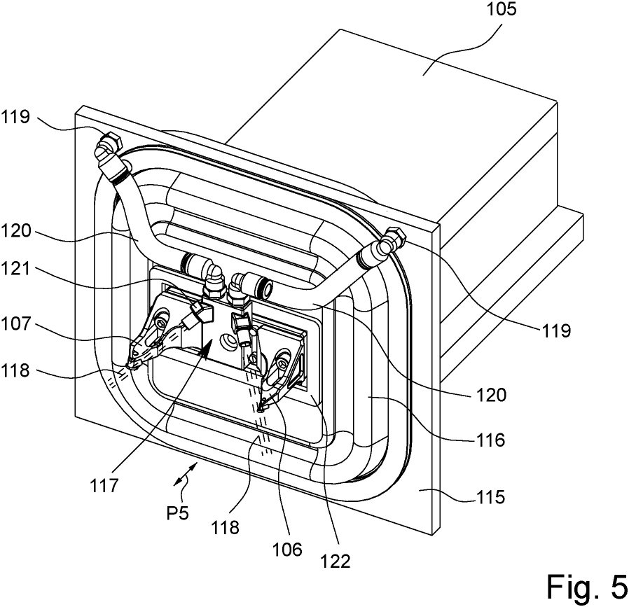

The turning station 100 preferably comprises a (first) fast tool drive 105 with at least one preferably protruding lathe tool / turning tool 106. In the illustrated example, the fast tool drive 105 optionally also has an additional or second lathe tool / turning tool 107, as indicated in FIGS. 1 and 5.

By means of the fast tool drive 105, the turning tool 106 and/or 107 can be moved back and forth very quickly, in particular with an acceleration of more than 1 g (=̂ 9.81 m s⁻² ), particularly preferably several g, in order to process the lens 2, which is rotating by means of the workpiece spindle 101, at the end face and to shape the end face of the lens 2 in a desired manner by means of corresponding axial movements of the turning tool 106 and/or 107. In particular, the turning tool 106 and/or 107 can be moved back and forth one or more times within one revolution of the lens 2.

The turning station 100 optionally comprises an additional or second fast tool drive 108 having at least one lathe tool / turning tool 109.

In particular, the fast tool drives 105 and 108 are used for sequential processing of the same lens 2, for example, to enable rough processing first and then fine processing.

In particular, the two fast tool drives 105 and 108 are embodied differently. For example, one has a roller bearing and the other an air bearing. This enables, for example, slightly faster and therefore less erosive processing on the one hand and slightly slower and therefore more erosive processing on the other hand.

The axis of movement of the turning tool(s) 106, 107, 109 preferably runs in the Z direction and/or in extension of or parallel to the rotary axis or rotation axis C of the workpiece spindle 101 and/or horizontally and/or in the Z direction, as indicated by arrow P5.

The workpiece spindle 101 is movable in the horizontal direction and/or X-direction transversely to the respective turning tool 106, 107 or 109 which lies opposite it in each case during the turning (chip-removing) machining, so that the turning tool 106, 107, 109 can basically be moved over the entire end face when the lens 2 is rotated. Here it is important that the turning tool 106, 107, 109 is also moved exactly over the center of the lens 2 and/or through the rotation axis C and not laterally past it. For adjustment purposes, the turning station 100 therefore preferably has a height adjustment device in order to be able to adjust the at least one fast tool drive 105, 108 relative to the workpiece spindle 101 in the vertical direction and/or Y-direction and/or transversely to the rotation axis C and axis of movement X.

Preferably, the turning station 100 has a wedge adjustment 110 for height adjustment, thus for adjustment in the Y direction.

The wedge adjustment 110 is preferably assigned to the fast tool drive 105 or fast tool drives 105, 108 and/or preferably has a movement component, in particular a horizontal movement component, parallel to the movement axis X of the workpiece spindle 101 and/or in the X direction and/or transverse to the rotation axis C of the workpiece spindle 101.

The wedge adjustment 110 and/or strongest inclination of an inclined plane S of the wedge adjustment 110 preferably runs in the X-Y plane, thus perpendicular to the rotation axis C of the workpiece spindle 101 and/or to the infeed axis Z.

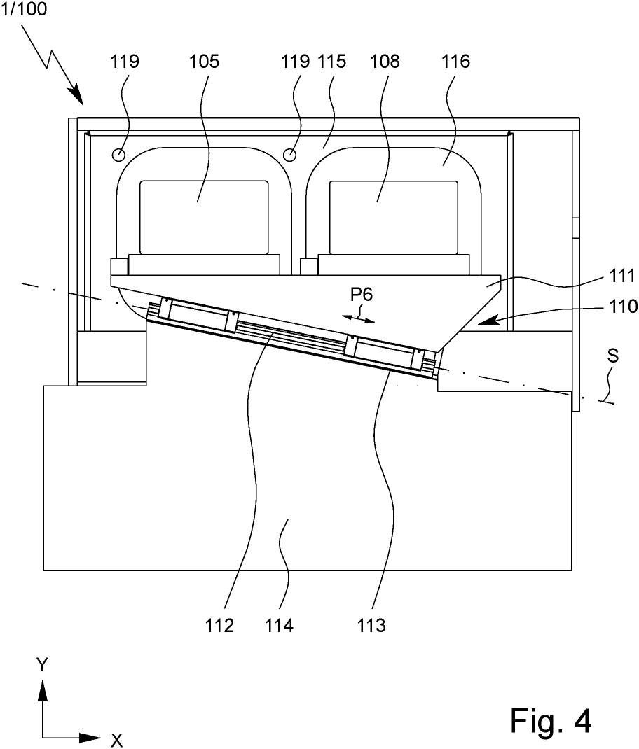

Preferably, the at least one fast tool drive 105 and/or the fast tool drives 105, 108 are arranged on a (common) slide/carriage 111, which is movable along the inclined plane S via a slide guide / carriage guide 112, as shown in the schematic side view of the turning station 100 according to FIG. 4 or indicated by arrow P6.

Preferably, the (respective) fast tool drive 105, 108 and/or the (respective) rotary tool 106, 107, 109 has only two axes of motion and/or is movable in only two directions, in particular in the Z-direction and in the direction of the inclined plane S.

Consequently, the (respective) fast tool drive 105, 108 and/or the (respective) turning tool 106, 107, 109 preferably only has a maximum of two stacked axes of motion.

Since the workpiece spindle 101 preferably has only one linear motion axis (and one rotary axis C), the turning station 100 thus preferably has only a maximum of two stacked motion axes. A device and/or spindle and/or drive having three or more stacked motion axes is preferably not provided.

The carriage guide 112 of the wedge adjustment 110 and/or of the carriage 111 is preferably arranged and/or mounted on a correspondingly inclined bearing surface / support surface 113 of a machine bed 114 of the turning station 100.

The bearing surface 113 and/or inclined plane S is preferably most inclined in the X direction and/or to the horizontal, in particular by about 5° to 15°, particularly preferably about 10° to 12°.

The machine bed 114 of the turning station 100 is preferably supported independently and/or separately from the machine bed 17 of the milling station 10 and/or preferably supported correspondingly on the, in particular, common base frame 5 via damping elements 4 not shown. However, other constructive solutions are also possible.

Preferably, the working space of the turning station 100 is at least largely shielded, covered and/or separable and/or closable, with corresponding covers, partitioning / separating walls or the like being largely omitted for reasons of simplification. In FIG. 5, a partition wall portion 115 is indicated, which should move along correspondingly with the displacement of the carriage 111 of the wedge adjustment 110 and can, for example, be embodied in the manner of a louver/jalousie.

In addition, the fast tool drive 105 and/or 108 each preferably has associated therewith a bellows-like separating portion 116, as schematically indicated in FIG. 5, which allows a head 122 of the fast tool drive 105 and/or 108 to move back and forth with the respective turning tool, as indicated by arrow P5 in FIGS. 1 and 5.

FIG. 5 shows by way of example in a schematic perspective the (first) fast tool drive 105 with, in particular, both turning tools 106 and 107 as seen from the working space.

In accordance with an aspect of the present disclosure that can also be implemented independently, the fast tool drive 105 preferably comprises a cooling device 117 for cooling the at least one turning tool 106 and/or 107 by supplying a cooling liquid 118. In particular, the cooling liquid 118 is directed in the form of a jet onto the respective turning tool 106 or 107, as schematically indicated in FIG. 5.

In the illustrative example, the cooling device 117 preferably has at least one coolant supply via a passage 119 (preferably from the working space and/or through the partition wall portion 115 and/or separating portion 116) and/or a hose 120 (in the working space) and/or at least one discharge opening or nozzle 121 that directs the coolant jet onto the respective turning tool 106 and/or 107.

The cooling device 117 and/or its discharge nozzle 121 is preferably fixedly arranged or attached to the movable head 122 of the fast tool drive 105 with the turning tool 106 and/or 107.

In the case of two turning tools 106 and 107, the cooling device 117 is preferably arranged or fixed between them.

In the case of two turning tools 106 and 107, the cooling device 117 preferably has two discharge openings or nozzles 121 and, particularly preferably, also two separate coolant supplies, in particular each with a separate passage 119 and/or hose 120, in order to be able to cool the two turning tools 106 and 107 independently of one another as required.

Preferably, the machine bed 114 of the turning station 100 also forms a horizontal support surface / bearing surface 123 for the carriage guide 104 of the workpiece spindle 101, as indicated in FIG. 1.

The workpiece spindle 101 equipped with the lens 2 to be processed can be positioned in particular selectively in front of one of the two fast tool drives 105 or 108 and/or selectively in front of one of the turning tools 106, 107 or 109, in particular by moving the carriage 103 along the carriage guide 104 and/or in the X direction or according to arrow P4. Face processing or face turning is then performed by moving the respective turning tool 106, 107 or 109 axially back and forth accordingly, as indicated by arrow P5 in FIG. 1 and/or in the direction of the feed axis Z.

If the stroke is too small for this highly dynamic movement, thus if the turning tool must be additionally fed or advanced to the lens 2 to be processed, for example to compensate for different lens thicknesses, such an infeed can optionally be performed by an infeed integrated in the respective fast tool drive 105 or 108. However, other constructive solutions are also possible, for example by means of an additional carriage guide on the tool side or workpiece side.

After the turning processing of the lens 2, the workpiece spindle 101 is moved to the change position (to the left in FIG. 1) and/or beside the fast tool drives 105, 108 and/or below/underneath the transfer device 60.

In particular, the clamping chuck 102 of the workpiece spindle 101 in the change position and the receiving chuck 61 of the transfer device 60 in the horizontal tilting position are positioned in such a way that their X-positions and optionally or at least substantially also their Z-positions coincide in order to enable the desired simultaneous transfer / handing over of two lenses 2 by means of the double gripper 31 and/or the simultaneous pick-up of two lenses 2 by means of the double gripper 31. Optionally, namely, the transfer device 60 has a spring stroke for compensating for different lens thicknesses and/or Z-positions.

The processing direction Z or P5 of the fast tool drive 105 or the fast tool drives 105, 108 preferably runs horizontally and/or parallel to the rotation axis C of the workpiece spindle 101.

Furthermore, the proposed processing apparatus 1 and/or use leads in particular to the following advantages and also independently realizable aspects:

The workpiece spindle 11 of the milling station 10 preferably forms a first workpiece spindle of the processing apparatus 1, and the workpiece spindle 101 of the turning station 100 preferably forms a second workpiece spindle of the processing apparatus 1.

The two workpiece spindles 11, 101 preferably have parallel and/or coaxial rotation axes C, but are preferably movable only transversely or perpendicularly to each other.

According to a particularly preferred aspect of the present disclosure, the two workpiece spindles 11, 101 and/or their chucks 12, 102 preferably face each other and/or their rotation axes C preferably run coaxially or in extension (at least when the workpiece spindle 101 of the turning station 100 is in the change position). The changing device 30 is preferably arranged and/or mounted therebetween. This is conducive to a compact design/structure, wherein a lens change can be performed very quickly, in particular by a swiveling movement, here about the swivel axis B.

In particular, the changing device 30 and/or its swivel axis B is arranged and/or mounted between the two machine beds 17 and 114.

The swivel axis B is preferably stationary or fixed.

Preferably, starting from the conveying device 50, the turning station 100, the changing device 30 and the milling station 10 are arranged at least substantially one behind the other, and preferably transversely to the conveying direction X of the conveying device 50. This is conducive to a particularly compact design/structure of the processing apparatus 1 in the conveying direction X.

Another aspect of the present disclosure, which can also be implemented independently, is in particular that the turning processing and the milling processing preferably take place in a first (horizontal) plane or level E1 and the lens transfer/handover of the transfer device 60 and/or loading device 40 takes place outside or in another (horizontal) plane or level E2, in particular lying above the first plane E1, as indicated schematically in FIG. 2.

The processing apparatus 1 and/or turning station 100 preferably has a release device 124 shown in FIG. 1 with an actuator 125 to be able to open and close the chuck 102 of the workpiece spindle 101 in the change position to enable the lens 2 to be changed.

Particularly preferably, the release device 124 is designed as a separate device that does not have to be moved together with the workpiece spindle 101, but is arranged stationary.

Alternatively, the release device 124 can be movable together with or integrated into the workpiece spindle 101.

The release device 124 may optionally be independently movable.

An additional release device can also be installed at another position as needed, for example to enable a lens change independently of the changing device 30 and/or, as the case may be, manually. For example, the release device 124 can serve the automatic change, in particular in the change position of the workpiece spindle 101 as described, and additionally enable a manual change at another position of the workpiece spindle 101.

The release device 124 can act with the actuator 125 in particular axially on the workpiece spindle 101, in the example shown on the side facing away from the chuck 102, to open the chuck 102 or a spring collet acting therein, so as to enable a desired opening and closing of the chuck 102 in the change position.

In particular, the processing apparatus 1 permits an increase in throughput as a result of the preferred parallelization of milling and turning.

Another aspect that can also be realized independently is the reduction of the workpiece changing time, in particular due to the proposed use of the changing device 30, particularly preferably with the double gripper 31 that is movable linearly and also rotatable about the linear axis, and/or due to the arrangement of the stationary swivel axis B between the processing stations, here the milling station 10 and the turning station 100, and/or between the workpiece spindles 11, 101 and/or their chucks 12, 102.

The absence of cross-slide assemblies achieves greater rigidity, which is in particular beneficial to precision during processing and/or permits higher processing speeds.

The use of two turning tools 106, 107 on one fast tool drive 105 allows multi-stage processing and/or redundancy and thus particularly high production and/or high continuous throughput. This applies accordingly when using two fast tool drives 105.

It should be noted that the milling station 10, like the turning station 100, preferably has a largely enclosed working space for processing, the corresponding partitions, covers, (air) locks or the like not being described or shown here for reasons of simplification.

Preferably, the working space or parts, such as plates/sheets, of the workspace of the milling station 10 and/or turning station 100 are connected to the respective machine bed 17 or 114 in a vibration-decoupled manner. For example, protective plates may be decoupled from the respective working space and/or fast tool drive 105 and/or other processing drive, such as the milling drive 14, by means of damping elements.

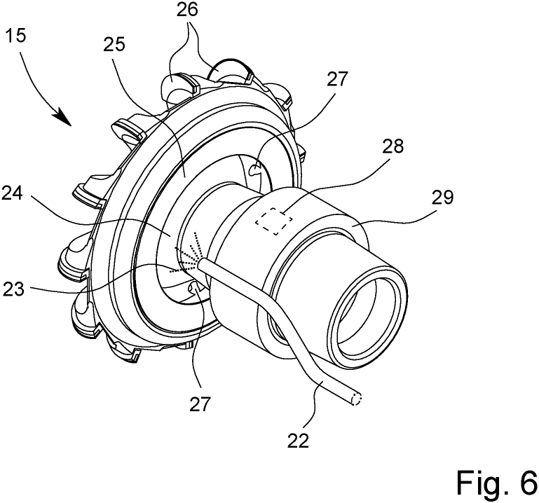

According to an aspect of the present disclosure that can also be implemented independently, the milling station 10 and/or the milling drive 14 is optionally also provided with a cooling device 22 for supplying a cooling liquid 23 and/or the cooling device 22 is associated with the milling tool 15, as indicated schematically in FIG. 6.

FIG. 6 shows in a schematic, perspective view from the rear the proposed milling tool 15, which or the milling head 25 of which is particularly preferably provided with a rear, in particular annular, groove-shaped or ring-groove-shaped recess or receptacle 24 for the cooling liquid 23 and/or has one or more through-holes 27 for discharging the cooling liquid 23 from the rear to the front and/or to milling teeth 26 of the milling tool 15 / milling head 25.

Preferably, a through hole 27 is associated in each milling tooth 26 for the supply of cooling liquid 23.

Preferably, the through holes 27 extend radially outward from the rear to the front of the milling tool 15 / milling head 25 so that the colling liquid 23 is conveyed by centrifugal forces to the front and/or to the milling teeth 26.

According to another aspect of the present disclosure that can also be implemented independently, the milling tool 15 is preferably provided with a recognition means 28, in particular an optical mark/sign or code or an RFID chip, particularly preferably on the milling head 25 or a shank or shaft 29 of the milling tool 15.

In particular, the cooling device 22 and/or the supply of coolant 23 is controllable depending on whether the milling tool 15 is constructed for liquid cooling. This can depend, for example, on whether the recognition means 28 is detected and/or what information is provided by the recognition means 28, for example about the number of through holes, a tool identification, number of teeth, etc.

Individual aspects and features of the present disclosure can also be implemented independently of each other, but also in any combination.

The present disclosure relates in particular to any one of the following aspects which can be realized independently or in any combination, also in any combination with any aspects above:
1. Processing apparatus 1 for processing optical workpieces, in particular lenses 2, with a milling station 10 comprising a first workpiece spindle 11, with a turning station 100 comprising a second workpiece spindle 101, and with a changing device 30 for changing the lenses 2 to be processed from the first workpiece spindle 11 to the second workpiece spindle 101,
characterized
   in that the workpiece spindles 11, 101 or their chucks 12, 102 face one another and/or the changing device 30 is arranged therebetween, and/or
   in that the milling station 10 and the turning station 100 each have only a maximum of two stacked movement axes X, Z, and/or
   in that the changing device 30 has a double gripper 31 which is rotatable about a central turn axis W and is movable linearly along the turn axis W and/or which – in particular by means of a cam mechanism 37 – is constructed for superimposed rotary and linear movement.
2. Processing apparatus according to aspect 1, characterized in that the first and/or second workpiece spindle 11, 101 is/are exclusively linearly displaceable in only one direction.
3. Processing apparatus according to aspect 1 or 2, characterized in that the milling station 10 and the turning station 100 each have a separate machine bed 17, 114 and that the changing device 30 is mounted independently of and/or between the machine beds 17, 114.
4. Processing apparatus according to one of the preceding aspects, characterized in that the changing device 30 has an in particular vertical swivel axis B for changing between the milling station 10 and turning station 100 and vice versa.
5. Processing apparatus according to one of the preceding aspects, characterized in that the changing device 30 is adapted for moving, in particular linearly, to a transfer position and/or transfer device 60 for picking up an unprocessed workpiece and/or handing over a processed workpiece, the transfer position and/or transfer device 60 being located directly on, above or below a change position of a workpiece spindle 101, in particular of the turning station 100.
6. Processing apparatus 1 for processing optical workpieces, in particular lenses 2, in particular according to one of the preceding claims,
   with a milling station 10 having a first carriage 13 with a workpiece spindle 11 and a second carriage 16 with a milling drive 14 as well as a machine bed 17,
   wherein the machine bed 17 supports the first carriage 13 on a first bearing surface 18 and the second carriage 16 on a second bearing surface 19,
   characterized
   in that the two bearing surfaces 18, 19 are inclined to each other by more than 45 degrees and/or in that the second bearing surface 19 runs parallel to the rotation axis D of the milling drive 14.
7. Processing apparatus according to aspect 6, characterized in that the second bearing surface 19 is inclined by more than 45 degrees to the horizontal.
8. Processing apparatus according to aspect 6 or 7, characterized in that the workpiece spindle 11 is exclusively linearly displaceable in only one direction Z.
9. Processing apparatus 1 for processing optical workpieces, in particular lenses 2, in particular according to one of the preceding claims,
   with a turning station 100 preferably designed for face turning, which has a workpiece spindle 101 and a first fast tool drive 105,
   characterized
   in that the turning station 100 has a second fast tool drive 108 which is constructed differently from the first fast tool drive 105 and/or which is provided for alternative and/or sequential processing of the same workpiece, and/or
   in that the turning station 100 has a wedge adjustment 110 for the fast tool drive 105 and/or the two fast tool drives 105, 108, and/or
   in that the first fast tool drive 105 has two tool holders and/or tools 106, 107 for alternative and/or sequential processing of a workpiece and/or has a tool cooling 117.
   10. Processing apparatus according to aspect 9, characterized in that the first fast tool drive 105 and the second fast tool drive 108 are arranged together on a carriage 111.
11. Processing apparatus according to one of the preceding aspects, characterized in that the processing apparatus 1 comprises two workpiece spindles 11, 101 which are offset and/or spaced apart in the direction of their parallel and/or coaxial rotation axes C.
12. Use of a double gripper 31 or method to use a double gripper 31,
   wherein the double gripper 31 is rotatable about a turn axis W and linearly movable along the turn axis W and/or– in particular by means of a cam mechanism 37 – is constructed for superimposed rotary and linear movement, and/or
   wherein by means of the double gripper 31 a workpiece still to be processed is transferred to a processing station 100 and/or its workpiece spindle 101 and simultaneously a workpiece already processed is transferred to a transfer device 60 and/or loading device 40 or other device,

to change optical workpieces, in particular lenses 2, for processing in a processing apparatus 1 or processing station 10, 100 and in particular between different processing stations 10, 100 of the processing apparatus 1.

List of reference signs:

| | | | |
|---|---|---|---|
| 1 | Processing apparatus | 31 | Double gripper |
| 2 | Lens | 32 | Gripping member / Sucker |
| 3 | Block piece | 33 | Carrier |
| 4 | Damping element | 34 | Arm |
| 5 | Base frame | 35 | Drive |
| | | 36 | Cam mechanism |
| 10 | Milling station | 37 | Swivel drive |
| 11 | Workpiece spindle | 40 | Loading device |
| 12 | Chuck | 41 | Manipulator |
| 13 | Carriage | 42 | Gripping member / Sucker |
| 14 | Milling drive | 43 | Carriage guide |
| 15 | Milling tool | | |
| 16 | Carriage | 50 | Conveying device |
| 17 | Machine bed | 51 | Transport carrier |
| 18 | First bearing surface | | |
| 19 | Second bearing surface | 60 | Transfer device |
| 20 | Carriage guide | 61 | Receiving chuck |
| 21 | Carriage guide | | |
| 22 | Cooling device | 100 | Turning station |
| 23 | Cooling liquid | 101 | Workpiece spindle |
| 24 | Receptacle | 102 | Chuck |
| 25 | Milling head | 103 | Carriage |
| 26 | Milling tooth | 104 | Carriage guide |
| 27 | Through hole | 105 | Fast tool drive |
| 28 | Recognition means | 106 | Turning tool |
| 29 | Shaft | 107 | Turning tool |
| | | 108 | Fast tool drive |
| 30 | Changing device | 109 | Turning tool |
| 110 | Wedge adjustment | 125 | Actuator |
| 111 | Carriage | | |
| 112 | Carriage guide | B | Swivel axis |
| 113 | Bearing surface | C | Rotation axis (workpiece spindle) |
| 114 | Machine bed | D | Rotation axis (milling drive) |
| 115 | Partition wall portion | E1 | Plane |
| 116 | Separating portion | E2 | Plane |
| 117 | Cooling device | P1-6 | Arrow |
| 118 | Cooling liquid | S | Inclined plane |
| 119 | Passage | W | Turn axis |
| 120 | Hose | X | Transverse motion axis / conveying direction |
| 121 | Nozzle | | |
| 122 | Head | Y | Vertical axis |
| 123 | Bearing surface | Z | Infeed axis |
| 124 | Release device | | |

What is claimed is:

1. Processing apparatus for processing optical workpieces,
with a milling station comprising a first workpiece spindle,
with a turning station comprising a second workpiece spindle, and
with a changing device for changing the workpieces to be processed from the first workpiece spindle to the second workpiece spindle,
wherein the processing apparatus comprises at least one of the following features:
the workpiece spindles or their chucks face one another and/or the changing device is arranged therebetween,
the milling station and the turning station each have only a maximum of two stacked movement axes, or
the changing device has a double gripper which is rotatable about a central turn axis and is movable linearly along the turn axis and/or which is constructed for superimposed rotary and linear movement.

2. Processing apparatus according to claim 1, wherein at least one of the first or second workpiece spindle is exclusively linearly displaceable in only one direction.

3. Processing apparatus according to claim 1, wherein the milling station and the turning station each have a separate machine bed and wherein the changing device is mounted independently of and/or between the machine beds.

4. Processing apparatus according to claim 1, whereinthe changing device has a swivel axis for changing between the milling station and turning station and vice versa.

5. Processing apparatus according to claim 1, whereinthe changing device is adapted for moving to a transfer position or transfer device for picking up an unprocessed workpiece and/or handing over a processed workpiece, the transfer position or transfer device being located directly on, above or below a change position of a workpiece spindle.

6. Processing apparatus according to claim 1, wherein the double gripper has two gripping members or suckers which point parallel to each other in the same direction.

7. Processing apparatus according to claim 1, wherein the changing device is constructed to transfer the workpieces in such a way that the workpieces are processable on the same flat side both in the milling station and in the turning station.

8. Processing apparatus according to claim 1, wherein the changing device comprises a cam mechanism for superimposed rotary and linear movement of the double gripper.

9. Processing apparatus according to claim 1, wherein the first and second workpiece spindles are offset and/or spaced apart in the direction of their parallel and/or coaxial rotation axes.

10. Processing apparatus according to claim 1, wherein the workpiece spindles or their chucks face one another, the changing device is arranged therebetween and the changing device has a double gripper which is rotatable about a central turn axis and is movable linearly along the turn axis.

11. Processing apparatus according to claim 1,
wherein the milling station has a first carriage with the first workpiece spindle and a second carriage with a milling drive as well as a machine bed,
wherein the machine bed supports the first carriage on a first bearing surface and the second carriage on a second bearing surface,
wherein the two bearing surfaces are inclined to each other by more than 45 degrees and/or wherein the second bearing surface runs parallel to the rotation axis of the milling drive.

12. Processing apparatus according to claim 1, wherein the turning station has a first fast tool drive and a second fast tool drive which is constructed differently from the first fast tool drive and/or which is provided for alternative or sequential processing of the same workpiece.

13. Processing apparatus according to claim 1, wherein the turning station has at least one fast tool drive and further has a wedge adjustment for the at least one fast tool drive or a common wedge adjustment for two fast tool drives.

14. Processing apparatus according to claim 1, wherein the turning station has a fast tool drive, and wherein the fast tool drive has two tool holders or tools for alternative or sequential processing of a workpiece and/or has a tool cooling.

15. Processing apparatus for processing optical workpieces,
with a milling station having a first carriage with a workpiece spindle and a second carriage with a milling drive as well as a machine bed,
wherein the machine bed supports the first carriage on a first bearing surface and the second carriage on a second bearing surface,
wherein the two bearing surfaces are inclined to each other by more than 45 degrees and/or wherein the second bearing surface runs parallel to the rotation axis of the milling drive.

16. Processing apparatus according to claim 15, wherein the second bearing surface is inclined by more than 45 degrees to the horizontal.

17. Processing apparatus according to claim 15, wherein the workpiece spindle is exclusively linearly displaceable in only one direction.

18. Processing apparatus for processing optical workpieces,
with a turning station which has a workpiece spindle and a first fast tool drive,
wherein the processing apparatus comprises at least one of the following features:
the turning station has a second fast tool drive which is constructed differently from the first fast tool drive and/or which is provided for alternative or sequential processing of the same workpiece,
the turning station has a wedge adjustment for the first fast tool drive or for both the first and second fast tool drives, or
the first fast tool drive has two tool holders or tools for alternative or sequential processing of a workpiece and/or has a tool cooling.

19. Processing apparatus according to claim 18, wherein the first fast tool drive and the second fast tool drive are arranged together on a carriage.

20. Processing apparatus according to claim 18,
wherein the processing apparatus further comprises a milling station having a first carriage with a milling workpiece spindle and a second carriage with a milling drive as well as a machine bed,
wherein the machine bed supports the first carriage on a first bearing surface and the second carriage on a second bearing surface,
wherein the two bearing surfaces are inclined to each other by more than 45 degrees and/or wherein the second bearing surface runs parallel to the rotation axis of the milling drive.
